(19) United States
(12) Patent Application Publication
(10) Pub. No.: US 2024/0193789 A1
(43) Pub. Date: Jun. 13, 2024

(54) SELECTIVE MOTION DISTORTION CORRECTION WITHIN IMAGE FRAMES

(71) Applicant: QUALCOMM Incorporated, San Diego, CA (US)

(72) Inventors: Nitin Bandwar, San Diego, CA (US); Pia Zobel, Hinanit (IL); Bing Han, San Diego, CA (US); Roee Hardoon, Zichron Yaakov (IL); Sungwon Lee, Huntington Beach, CA (US); Tauseef Kazi, San Diego, CA (US)

(21) Appl. No.: 18/064,542

(22) Filed: Dec. 12, 2022

(51) Int. Cl. G06T 7/20; G06T 1/20; G06V 10/25; G06V 10/74; H04N 23/68

(52) U.S. Cl. CPC G06T 7/20; G06T 1/20; G06V 10/25; G06V 10/761; H04N 23/682; G06T 2207/20024

(57) ABSTRACT

This disclosure provides systems, methods, and devices for image signal processing that support improved correction of motion artifacts within image frames. In a first aspect, a method of image processing includes receiving a first image frame and a second image frame, determining a motion map indicating motion of objects within the first and second image frames. Additionally, motion hotspots may be identified within the second image frame based on the motion map. A temporal filtering process may be applied to portions of the second image frame located within motion hotspots to generate a corrected image frame. Other aspects and features are also claimed and described.

### TECHNICAL FIELD

Aspects of the present disclosure relate generally to image processing, and more particularly, to image processing performed on image frames to correct for movement within the image frames. Some features may enable and provide improved image processing, including an improved use of motion compensated temporal filtering (McTF) to reduce the overall computing resources required to correct image frames using the McTF technique, particularly for image frames of captured video.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The amount of image data captured by an image sensor has increased through subsequent generations of image capture devices. The amount of information captured by an image sensor is related to a number of pixels in an image sensor of the image capture device, which may be measured as a number of megapixels indicating the number of millions of sensors in the image sensor. For example, a 12-megapixel image sensor has 12 million pixels. Higher megapixel values generally represent higher resolution images that are more desirable for viewing by the user.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display or transmitted to a recipient in a message. Each of the processing blocks consumes additional power proportional to the amount of image data, or number of megapixels, in the image capture. The additional power consumption may shorten the operating time of an image capture device using battery power, such as a mobile phone.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects of the disclosure, temporal filtering may be applied or not applied to portions of an image frame based on motion detected within the image frame. The selective operation of temporal filtering on portions of the image data reduce the amount of processing performed by a processor applying the temporal filtering, which may reduce power consumption and increased operating speed. The temporal filtering may be applied to remove distortions within image frames caused by movement of subjects while capturing image frames for composition into a single still image or as part of a video sequence. For example, the temporal filtering selectively applied to regions of the image frame may reduce distortions caused from movement of one or more objects within an image frame that blur and/or blend together.

The motion map may indicate local movement of objects depicted within the second image frame in the first image frame. Additionally or alternatively, the motion map may reflect global motion of the device used to capture the image frames. Motion hotspots may also be identified based on the motion map. The motion hotspots may identify corresponding portions of the second image frame that contain or are likely to contain motion distortion and/or motion artifacts. In particular, the motion hotspots may be determined to identify portions of the second image frame with motion greater than or equal to a predetermined threshold. A temporal filtering process may then be applied to portions of the second image frame that are located within motion hotspots to generate a corrected image frame. Applying the temporal filtering process may include determining an image transform matrix, such as a motion compensation transform matrix. The image transform matrix may be determined based on the motion map and/or the first and second image frames. The image transform matrix may be determined such that, when applied to pixels or other portions of the second image frame (e.g., blocks, superblocks, macroblocks, regions), motion distortion and/or motion artifacts are corrected (e.g., removed, lessened). The corrected image frame may then be added to an output file. This process may be repeated to process multiple image frames. For example, this process may be sequentially repeated across all of the received image frames (e.g., in the order in which the image frames are captured and/or received).

In some aspects, the temporal filtering process applied for correcting the image frame is motion-compensated temporal filtering (MCTF) process. MCTF reduces noise and/or motion artifacts in video by filtering areas of motion based on global and/or local motion determinations for a current frame relative to a previous frame. Selectively performing MCTF filtering only on identified regions meeting certain criteria may reduce core power consumption when processing scenes with limited motion within the field of view (FOV).

In some aspects, the techniques described herein relate to a method, including: receiving a first image frame and a second image frame; determining a motion map based on the second image frame and the first image frame; determining, based on the motion map, a region of the second image frame having motion that satisfies at least one criteria; and determining a corrected image frame by applying a temporal filtering process to the region.

In some aspects, the techniques described herein relate to an apparatus, including: a memory storing processor-readable code; and at least one processor coupled to the memory, the at least one processor configured to execute the processor-readable code to cause the at least one processor to perform operations including: receiving a first image frame and a second image frame; determining a motion map based on the second image frame and the first image frame; determining, based on the motion map, a region of the second image frame having motion that satisfies at least one criteria; and determining a corrected image frame by applying a temporal filtering process to the region.

In some aspects, the techniques described herein relate to a non-transitory computer-readable medium storing instructions that, when executed by a processor, cause the processor to perform operations including: receiving a first image frame and a second image frame; determining a motion map based on the second image frame and the first image frame; determining, based on the motion map, a region of the second image frame having motion that satisfies at least one criteria; and determining a corrected image frame by applying a temporal filtering process to the region.

In some aspects, the techniques described herein relate to an image capture device, including: an image sensor; a memory storing processor-readable code; and at least one processor coupled to the memory and to the image sensor, the at least one processor configured to execute the processor-readable code to cause the at least one processor to: receive a first image frame and a second image frame in image data received from the image sensor; determining a motion map based on the second image frame and the first image frame; determining, based on the motion map, a region of the second image frame having motion that satisfies at least one criteria; and determining a corrected image frame by applying a temporal filtering process to the region.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 is a block diagram of an example implementation of an engine for video analytics and an image processing engine according to an exemplary embodiment of the disclosure.

FIG. 4 shows a flow chart of an example method for processing image frames to correct for motion according to some embodiments of the disclosure.

FIG. 5 is a block diagram illustrating an example processor configuration for image data processing in an image capture device according to one or more embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Various techniques exist for correcting motion distortion within captured image frames. For example, motion compensated temporal filtering (McTF) processing allows for video systems to reduce noise and motion artifacts within capture images. However, these techniques are often computing resource intensive. Furthermore, video processing pipelines often require real time or near real time processing of captured image frames to ensure that the video pipeline is able to keep up with incoming image frames to continue capturing video data. Thus, the intensive level of computing resources required by the McTF and other techniques may reduce device battery life while capturing video. Additionally, processing constraints for mobile computing devices may limit the overall amount of computing resources that may be provided to a video processing pipeline. Accordingly, limited resources may also restrict the amount a video that can be captured (e.g., may restrict a video capture resolution, video capture frame rate, bitrate, and the like).

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

The present disclosure provides systems, apparatus, methods, and computer-readable media that support image processing, including techniques for improved processing and correction of motion distortion within captured image frames caused by movement of objects within the image frames. In particular, an image transform matrix may be generated to correct motion distortion within a received image frame. Additionally, a motion map computed to indicate movement of objects within the image frame may be analyzed to identify one or more motion hotspots within the image frame. The motion hotspots may then be used to constrain application of a temporal filtering process to the image frame. For example, the temporal filtering process may only be applied to portions of image frame where the motion hotspots indicate movement greater than a predetermined threshold.

Particular implementations of the subject matter described in this disclosure may be implemented to realize one or more of the following potential advantages or benefits. In some aspects, the present disclosure provides techniques for reducing the overall amount of computing resources necessary to detect and correct motion distortion within captured image frames. In particular, by restricting the application of one or more motion distortion correction techniques to only include areas where sufficient motion has taken place, the techniques may reduce the overall proportion of an image that needs to be modified or transformed to correct for the motion distortion. This may result an improved device battery life for image capturing devices that implement these techniques. Similarly, these techniques may reduce overall device heat and associated cooling requirements. Relatedly, by reducing the amount of image processing that needs to be performed, the techniques may improve the capabilities of image capturing devices to, e.g., capture processed video data at higher resolutions, higher frame rates, higher bitrates, and the like.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

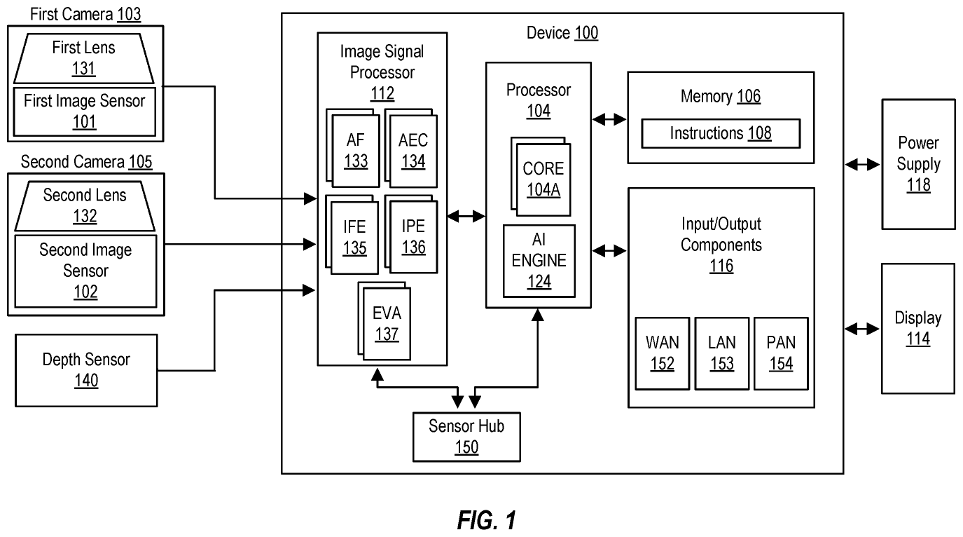

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The camera 103 may have different characteristics based on the current aperture size, such as a different depth of focus (DOF) at different aperture sizes.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), one or more auto exposure compensation (AEC) 134 engines, and/or one or more engines for video analytics (EVAs). The AF 133, AEC 134, IFE 135, IPE 136, and EVA 137 may each include application-specific circuitry, be embodied as software code executed by the ISP 112, and/or a combination of hardware and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including motion distortion detection and correction operations. For example, execution of the instructions can instruct the image signal processor 112 to begin or end capturing an image frame or a sequence of image frames, in which the capture includes motion distortion or other motion errors as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

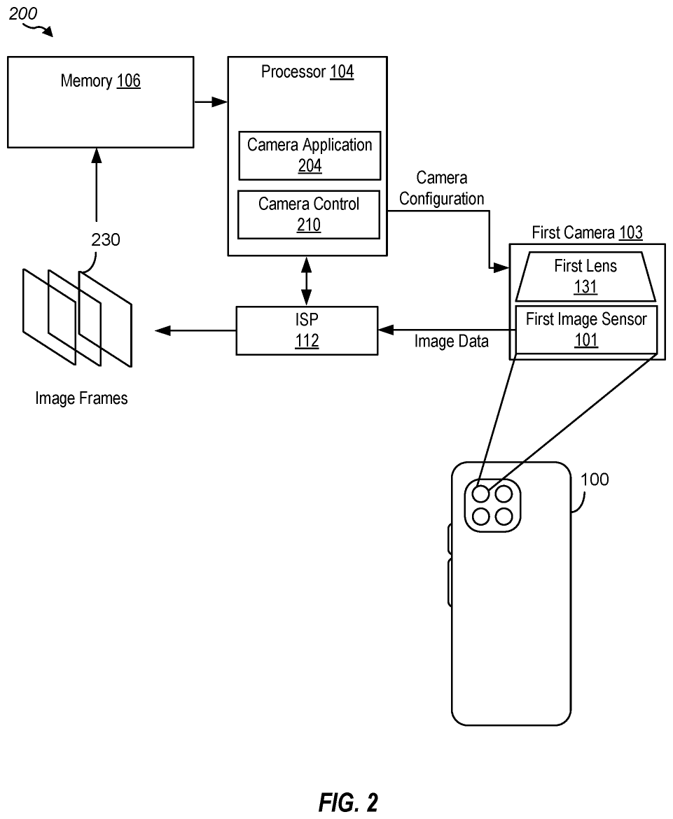

The exemplary image capture device of FIG. 1 may be operated to obtain improved images and/or videos by adjusting the application of one or more motion distortion correction techniques (e.g., McTF) based on motion hotspots detected within received image frames. A motion hotspot refers to a portion of an image frame that meets at least one criteria regarding motion, such as a determined motion amount above a threshold, which may be determined based on one or more motion vectors corresponding to the portion of the image frame. One example method of operating one or more cameras, such as camera 103, is shown in FIG. 2 and described below.

FIG. 2 is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as for configuring the camera 103 through a driver executing on the processor 104. The camera control 210 may be managed by a camera application 204 executing on the processor 104, which provides settings accessible to a user such that a user can specify individual camera settings or select a profile with corresponding camera settings. The camera control 210 communicates with the camera 103 to configure the camera 103 in accordance with commands received from the camera application 204. The camera application 204 may be, for example, a photography application, a document scanning application, a messaging application, or other application that processes image data acquired from camera 103.

The camera configuration may parameters that specify, for example, a frame rate, an image resolution, a readout duration, an exposure level, an aspect ratio, an aperture size, etc. The camera 103 may obtain image data based on the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

In some embodiments in which camera 103 is a variable aperture (VA) camera system, the processor 104 may execute a camera application 204 to instruct camera 103 to configure to a first aperture size, obtain first image data from the camera 103, instruct camera 103 to configure to a second aperture size, and obtain second image data from the camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 is a larger aperture size than f/8.0.

The image data received from camera 103 may be processed in one or more blocks of the ISP 112 to form image frames 230 that are stored in memory 106 and/or provided to the processor 104. The image frames 230 output by the ISP 112 may have motion-compensated temporal filtering (McTF) selectively applied to motion hotspots and/or other regions of the image frame. The McTF applied by the ISP 112 may be applied to determine a corrected image frame based on a first image frame and a second image frame received in the image data from the first camera 103. The processor 104 may further process the image data to apply effects to the image frames 230. Effects may include Bokeh, lighting, color casting, and/or high dynamic range (HDR) merging. In some embodiments, functionality may be embedded in a different component, such as the ISP 112, a DSP, an ASIC, or other custom logic circuit for performing the additional image processing.

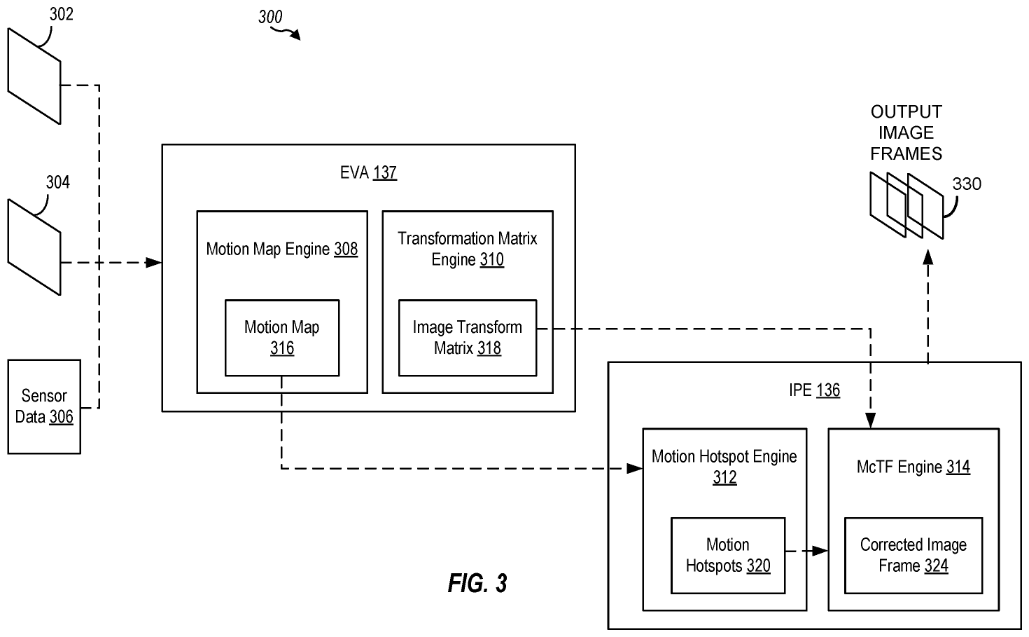

FIG. 3 is a block diagram of system 300 including an example implementation of the engine for video analytics (EVA) 137 and the image processing engine (IPE) 136 according to an exemplary embodiment of the disclosure. In the system 300, the EVA 137 receives a first image frame 302, a second image frame 304, and sensor data 306. The first image frame 302 and the second image frame 304 may be received as image data from an image sensor, such as the image sensors 101, 102. In certain instances, the EVA 137 may be configured to receive and sequentially process image frames (e.g., as part of an image processing pipeline and/or a video processing pipeline). For example, the EVA 137 may initially receive the first image frame 302 (e.g., after being captured by the image sensor 101, 102) it may subsequently receive the image frame 304 (e.g., after being subsequently captured by the image sensor 101, 102). In certain instances, the second image frame 304 may be considered a current image frame, or target image frame of an image processing or video processing pipeline, and the first image frame 302 may be considered a reference frame of the pipeline. In additional or alternative implementations, the EVA 137 may receive a plurality of image frames including the image frames 302, 304. For example, a plurality of image frames may be previously stored and may be retrieved by the EVA 137 for further processing. The sensor data 306 may be received from a sensor hub, such as the sensor hub 150. The sensor data 306 may include data from one or more movement sensors, such as accelerometers and gyroscopes. The sensor data 306 may reflect movement of a device used to capture the image frames 302, 304, such as the device 100.

The EVA 137 contains a motion map engine 308, which may be configured to generate a motion map 316. The motion map 316 may be generated to indicate motion within the second image frame 304 relative to the first image frame 302. In certain implementations, the motion map 316 may be computed based on differences between the second image frame 304 and the first image frame 302. In additional or alternative implementation, the motion map 316 may be computed based on sensor data 306 (e.g., motion sensor data) from a device 100 (e.g., an image capture device) that captured the first image frame 302 and the second image frame 304. For example, the motion map engine 308 may be configured to compute one or more global motion estimates reflecting movement of the image capture device and local motion estimates reflecting movement of one or more objects depicted within the image frames 302, 304. In certain instances, the global motion estimates may be calculated based on sensor data 306, such as gyroscope or accelerometer data indicating movement of the image capture device. The global motion estimates may include one or both of a magnitude and direction of movement for the image capture device. Local motion estimates may be captured by comparing the first and second image frames 302, 304. For example, the local motion estimates may be determined by comparing the locations of one or more objects within each of the first image frame 302 and the second image frame 304. The local motion estimates may be computed as differences between the image frames 302, 304. As another example, local motion estimates may be calculated based on texture processing using Harris corner detection and related techniques. Local motion estimates and/or global motion estimates may then be combined to generate the motion map 316.

In certain implementations, the motion map 316 may be implemented separately from the second image frame 304 (e.g., as a separate data structure that corresponds to the second image frame 304). In additional or alternative implementations, the motion map 316 may be implemented as a portion of the second image frame 304 (e.g., as a data layer or metadata layer of the second image frame 304). Furthermore, the contents of the motion map 316 may correspond to particular portions of the second image frame 304. For example, each pixel of the second image frame 304 may have a corresponding entry in the motion map 316. As another example, each entry in the motion map 316 may correspond to multiple pixels (e.g., 4 pixels, 9 pixels, 16 pixels, or more). The contents of the motion map 316 may indicate movement within corresponding portions of the second image frame 304. For example, entries in the motion map 316 may indicate a magnitude of movement for an object or feature depicted within a corresponding portion of the second image frame 304 (e.g., relative to the first image frame 302). In various implementations, the magnitude of movement may be indicated as one or more of a number of pixels of movement, a distance of movement, a speed of movement, and the like. In certain implementations, the entries may also indicate a direction of movement.

In one specific implementation, the motion map 316 may be computed by the motion map engine 308 by comparing the second image frame 304 to the first image frame 302 to generate an estimate of motion vectors between the image frames 302, 304. The motion vectors and the sensor data 306 may then be analyzed together to determine an alignment of the image capture device (e.g., to separate global motion of the image capture device from local motion of objects depicted within the image frames 302, 304). The motion map engine 308 may then perform a matching process based on the alignment and the image frames 302, 304 to generate the motion map 316. In certain implementations, the matching process may be performed as a semi-global matching (SGM) process.

The motion map 316 may then be used to generate the image transform matrix 318. For example, the image transform matrix 318 may be generated to indicate image transformations that should be applied to the second image frame 304 to correct for motion distortions within the second image frame 304. The image transform matrix 318 may contain image transformations based on individual pixels within the second image frame 304 and/or one or more adjacent pixels within the image frame 304. Additionally or alternatively, the image transform matrix 318 may include transformations based on other image frames (e.g., image frames 302 captured before the image frame 304 and/or image frames captured after the image frame 304). In various implementations, the image transform matrix 318 may contain the same or similar transformations for every pixel and/or portion of the second image frame 304. In additional or alternative implementations, the image transform matrix 318 may indicate different transformations for different pixels and/or different portions of the second image frame 304. In certain implementations, the motion map 316 may be generated according to one or more motion distortion correction techniques, such as McTF. In certain implementations, the image transform matrix 318 may be generated to reverse the movement of pixels blocks (such as 8 pixel by 8 pixel blocks) or other image features from the second image frame relative to the first image frame 302.

The IPE 136 may receive both the motion map 316 and the image transform matrix 318. In particular, the IPE 136 contains a motion hotspot engine 312, which may receive the motion map 316, and an McTF engine 314, which may receive the image transform matrix 318. The motion hotspot engine 312 may be configured to identify motion hotspots 320 within the second image frame of 304. The motion hotspots 320 may represent areas with significant motion and/or motion distortion within the second image frame 304. Additionally or alternatively, the motion hotspots 320 may represent areas within the second image frame 304 in which motion distortion is likely to be present. In certain implementations, the motion hotspots 320 may contain or otherwise identify locations within the second image frame 304 that have motion greater than or equal to a predetermined threshold. In particular, the motion map 316 may, in certain implementations, indicate motion within the second image frame 304 as a number of pixels of movement between the first image frame 302 and the second image frame 304 for corresponding portions of the second image frame 304. In such implementations, the motion hotspots 320 may be implemented as areas in which movement indicated by the motion map 316 is greater than a predetermined number of pixels (e.g., 1 pixel, 2 pixels, 4 pixels, 10 pixels, and the like).

In various implementations, the motion hotspots 320 may be stored in a format similar to that of the motion map 316. In certain implementations, the motion hotspots 320 may be implemented separately from the second image frame 304 (e.g., as a separate data structure that corresponds to the second image frame 304). In additional or alternative implementations, the motion hotspots 320 may be implemented as a portion of the second image frame 304 (e.g., as a data layer or metadata layer of the second image frame 304). Furthermore, the contents of the motion hotspots 320 may correspond to particular portions of the second image frame 304. For example, each pixel of the second image frame 304 may have a corresponding entry in the motion hotspots 320. As another example, each entry in the motion hotspots 320 may correspond to multiple pixels (e.g., 4 pixels, 9 pixels, 16 pixels, or more). In additional alternative implementations, the motion hotspots 320 may only be generated to contain indications of the locations of motion hotspots 320 within the second image frame 304. For example, the motion hotspots 320 may contain coordinates or other identifiers of a polygon or other bounded area containing the motion hotspots within the second image frame 304.

The McTF engine 314 may be configured to receive the motion hotspots 320 and the image transform matrix 318, and to generate a corrected image frame 324. In particular, the McTF 314 may be configured to apply a temporal filtering process (such as an McTF process) to the to the second image frame 304 to generate the corrected image frame 324. In certain implementations, applying the temporal filtering process may include applying the image transform matrix 318 to all or part of the second image frame 304. As explained above, applying the temporal filtering process to the entirety of the second image frame 304 may utilize excessive computing resources, reducing device battery life and image frame processing capacity. Instead, the McTF engine 314 may be configured to only apply the temporal filtering process to pixels of the second image frame 304 located within the motion hotspots 320. For example, the McTF engine 314 may analyze each of the pixels within the second image frame 304 and may determine, based on a corresponding portion of the motion hotspots 320, whether the pixel is contained within a motion hotspot. If the pixel is contained within a motion hotspot, the McTF engine 314 may apply the temporal filtering process to the pixel. The McTF engine 314 may iterate through all of the pixels within the second image frame 304 to generate the corrected image frame 324. As one specific example, FIG. 3 depicts an exemplary image frame with exemplary motion hotspots 332 identified. The McTF engine 314 may apply the temporal filtering process to these regions within the second image frame to generate the corrected image frame 324.

In additional or alternative implementations, the McTF engine 314 may instead analyze the motion hotspots 320 and may determine corresponding locations (e.g., corresponding pixels) of the second image frame 304 that are contained within the motion hotspots 320. The McTF engine 314 may then apply the image transform matrix 318 to the corresponding locations to generate the corrected image frame 324. Once generated, the IPE 136 may add the corrected image frame 324 to the output image frames 330 (e.g., output image frames for a video and/or composite image). In certain implementations, the corrected image frame 324 may also serve as a reference image frame for correcting future image frames. For example, the first image frame 302 may be an image frame that was previously corrected by the EVA 137 and the IPE 136 using the above-discussed techniques.

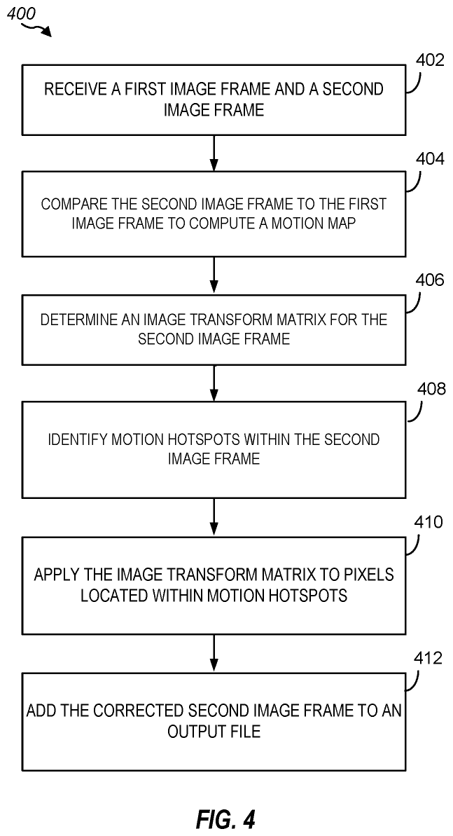

The system 200 of FIG. 2 and/or the system 300 of FIG. 3 may be configured to perform the operations described with reference to FIG. 4 to determine output image frames 230, 330 (e.g., for a video sequence). FIG. 4 shows a flow chart of an example method 400 for processing image frames to correct for motion according to some embodiments of the disclosure. The capturing in FIG. 4 may obtain an improved digital representation of a scene, which results in a photograph or video with higher image quality (IQ).

At block 402, a first image frame and a second image frame are received. The first and second image frames 302, 304 may be received from an image sensor 101, 102, such as while the image sensor is configured with the camera configuration. The first image frame and the second image frame may be received at ISP 112, processed through an image front end (IFE) and/or an image post-processing engine (IPE) of the ISP 112, and stored in memory. In some embodiments, the capture of image data may be initiated by a camera application executing on the processor 104, which causes camera control 210 to activate capture of image data by the camera 103, and cause the image data to be supplied to a processor, such as processor 104 or ISP 112. In certain instances, the first image frame 302 and the second image frame 304 may be received in sequence. For example, the first image frame 302 may be received before the second image frame 304.

At block 404, the second image frame is compared to the first image frame to compute a motion map. For example, the second image frame 304 may be compared to the first image frame 302 to compute a motion map 316. As explained further above, the motion map 316 may be computed based on one or both of local motion estimates and global motion estimates. For example, local motion estimates may be computed based on changes in location for one or more objects and/or features within the second image frame 304 and the first image frame 302. Additionally or alternatively, global motion estimates may be computed based on sensor data 306 reflecting movement of the device 100.

At block 406, an image transform matrix is determined for the second image frame. For example, an image transform matrix 318 may be determined for the second image frame 304 by an EVA 137 and/or a transformation matrix engine 310. In particular, the image transform matrix 318 may be determined to correct for one or more motion distortion artifacts or other errors within the second image frame 304. In various implementations, the image transform matrix 318 may be computed according to the McTF technique.

A block 408, motion hotspots are identified within the second image frame. For example, motion hotspots 320 may be identified within the second image frame 304 by a motion hotspot engine 312 and/or the IPE 136. The motion hotspots 320 may be identified as locations within the second image frame 304 that contain significant motion and/or motion distortion artifacts. As explained further above, in various implementations, the motion hotspots 320 may be identified as locations within the second image frame 304 corresponding to portions of the motion map 316 indicating motion that exceeds a predetermined threshold.

At block 410, a temporal filtering process is applied to pixels located within motion hotspots. For example, the McTF engine 314 and/or the IPE 136 may apply the temporal filtering process (such as an McTF process) to pixels of the second image frame 304 located within motion hotspots 320 to generate a corrected image frame 324. In certain implementations, applying the temporal filtering process may include applying the image transform matrix 318 to the second image frame 302 (such as pixels of the second image frame 304 located within motion hotspots 320).

At block 412, the corrected image frame is added to in output file. For example, the IPE 136 and/or the device 100 may add the corrected image frame 324 to an output file that contains one or more output image frames 330. The output image frames 230, 330 may be determined by the processor 104 or ISP 112 and stored in memory 106. The stored image frames may be read by the processor 104 and used to form a preview display on a display of the device 100 and/or processed to form a photograph for storage in memory 106 and/or transmission to another device. In certain implementations, the output image frames 330 may correspond to a video file. In such instances, the corrected image frame 324 may be appended as a frame of the video file (e.g., as the next sequential image frame of the video file).

Accordingly, the method 400 enables the improved detection and correction of motion distortion errors and artifacts within image frames captured by computing devices. In particular, the method 400 reduces the overall computing resources necessary to correct for motion distortion artifacts and other errors. These techniques may accordingly improve device battery life and increase the capacity of an image processing pipeline within the computing device, increasing the resolution, size, and/or frame rate of image frames and/or video frames that may be processed and corrected.

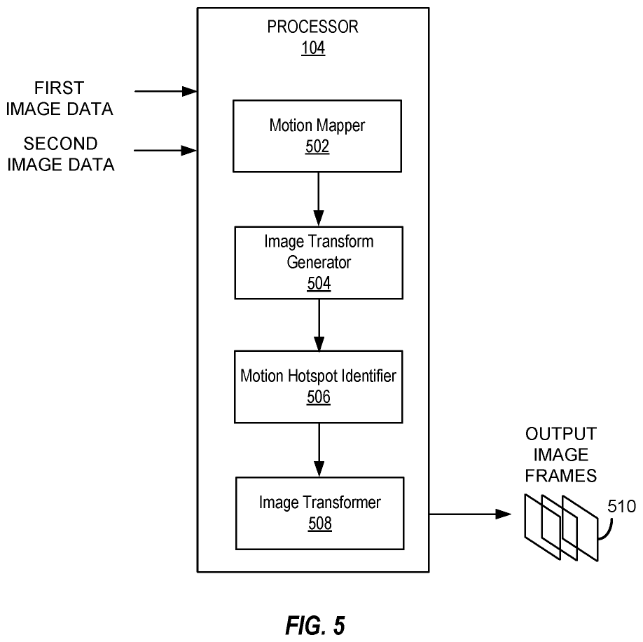

FIG. 5 is a block diagram illustrating an example processor configuration for image data processing in an image capture device according to one or more embodiments of the disclosure. The processor 104, or other processing circuitry, may be configured to operate on image data to perform one or more operations of the method of FIG. 4. The image data may be processed to determine one or more output image frames 510. In FIG. 5, the processor 104 implements a motion mapper 502, an image transform generator 504, a motion hotspot identifier 506, and an image transformer 508.

The processor 104 is configured to receive first image data and second image data. The first image data may represent a first image frame, and the second image data may represent a second image frame. The image data may be captured by an image sensor. The motion mapper 502 may be configured to compare the second image frame to the first image frame to compute a motion map for the second image frame. In particular, the motion map may be computed to indicate movement of one or more objects within the second image frame relative to the first image frame. Additionally or alternatively, the motion map may be computed to indicate movement of the device 100 used to capture the first and second image frames. The image transform generator 504 may be configured to determine, based on the motion map, and image transform matrix to correct the second image frame. In particular, the image transform matrix may be determined to correct for motion distortions and/or motion artifacts within the second image frame. In certain implementations, the image transform matrix 318 may be computed according to the McTF technique. The motion hotspot identifier 506 may be configured to identify, based on the motion map, motion hotspots within the second image frame. The image transformer 508 may be configured to generate a corrected image frame based on the second image frame, the image transform matrix, and the motion hotspots. In particular, the image transformer 508 may be configured to apply a temporal filtering process to portions of the second image frame located within motion hotspots to generate the corrected image frame. The corrected image frame may then be added to the output image frames 510.

In one or more aspects, techniques for supporting image processing may include additional aspects, such as any single aspect or any combination of aspects described below or in connection with one or more other processes or devices described elsewhere herein. In a first aspect, the techniques described herein relate to a method, including receiving a first image frame and a second image frame; determining a motion map based on the second image frame and the first image frame; determining, based on the motion map, a region of the second image frame having motion that satisfies at least one criteria; and determining a corrected image frame by applying a temporal filtering process to the region.

In a second aspect according to the first aspect, the at least one criteria includes movement that exceeds a predetermined threshold.

In a third aspect according to at least one of the first through second aspects, the method is performed by an image signal processor containing an image processing engine and an engine for video analytics.

In a fourth aspect according to the third aspect, applying the temporal filtering process to the region includes determining an image transform matrix, and the image transform matrix is determined by the image processing engine and the region is determined by the engine for video analytics.

In a fifth aspect according to at least one of the first through fourth aspects, the method is performed as part of an image processing pipeline, and the first image frame is a reference image frame of the image processing pipeline and the second image frame is a current image frame of the image processing pipeline.

In a sixth aspect according to at least one of the first through fifth aspects, the motion map reflects movement within the second image frame relative to the first image frame.

In a seventh aspect according to the sixth aspect, determining the motion map includes determining differences between the second image frame and the first image frame.

In an eighth aspect according to at least one of the sixth through seventh aspects, determining the motion map is based on motion sensor data from an image capture device that captured the first image frame and the second image frame.

In a ninth aspect according to at least one of the first through eighth aspects, the first image frame was previously transformed to correct motion errors prior to being compared with the second image frame to compute the motion map for the second image frame.

In a tenth aspect according to at least one of the first through ninth aspects, the image transform matrix is generated according to a motion compensated temporal filtering process.

In an eleventh aspect, an apparatus is provided that includes a memory storing processor-readable code; and at least one processor coupled to the memory, the at least one processor configured to execute the processor-readable code to cause the at least one processor to perform operations including receiving a first image frame and a second image frame; determining a motion map based on the second image frame and the first image frame; determining, based on the motion map, a region of the second image frame having motion that satisfies at least one criteria; and determining a corrected image frame by applying a temporal filtering process to the region.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon, and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a twelfth aspect according to the eleventh aspect, the at least one criteria includes movement that exceeds a predetermined threshold.

In a thirteenth aspect according to at least one of the eleventh through twelfth aspects, the at least one processor includes an image signal processor including an image processing engine and an engine for video analytics.

In a fourteenth aspect according to the thirteenth aspect, applying the temporal filtering process to the region includes determining an image transform matrix, and the image transform matrix is determined by the image processing engine and the region is determined by the engine for video analytics.

In a fifteenth aspect according to at least one of the eleventh through fourteenth aspects, the apparatus is performed as part of an image processing pipeline, and the first image frame is a reference image frame of the image processing pipeline and the second image frame is a current image frame of the image processing pipeline.

In a sixteenth aspect according to at least one of the eleventh through fifteenth aspects, the motion map reflects movement within the second image frame relative to the first image frame.

In a seventeenth aspect according to the sixteenth aspect, determining the motion map includes determining differences between the second image frame and the first image frame.

In an eighteenth aspect according to at least one of the sixteenth through seventeenth aspects, determining the motion map is based on motion sensor data from an image capture device that captured the first image frame and the second image frame.

In a nineteenth aspect according to at least one of the eleventh through eighteenth aspects, the first image frame was previously transformed to correct motion errors prior to being compared with the second image frame to compute the motion map for the second image frame.

In a twentieth aspect according to at least one of the eleventh through nineteenth aspects, the image transform matrix is generated according to a motion compensated temporal filtering process.

In a twenty-first aspect, the techniques described herein relate to a non-transitory computer-readable medium storing instructions that, when executed by a processor, cause the processor to perform operations including receiving a first image frame and a second image frame; determining a motion map based on the second image frame and the first image frame; determining, based on the motion map, a region of the second image frame having motion that satisfies at least one criteria; and determining a corrected image frame by applying a temporal filtering process to the region.

In a twenty-second aspect according to the twenty-first aspect, the at least one criteria includes movement that exceeds a predetermined threshold.

In a twenty-third aspect according to at least one of the twenty-first through twenty-second aspects, instructions further cause the processor to implement an image signal processor containing an image processing engine and an engine for video analytics.

In a twenty-fourth aspect according to the twenty-third aspect, applying the temporal filtering process to the region includes determining an image transform matrix, and the image transform matrix is determined by the image processing engine and the region is determined by the engine for video analytics.

In a twenty-fifth aspect according to at least one of the twenty-first through twenty-fourth aspects, the motion map reflects movement within the second image frame relative to the first image frame.

In a twenty-sixth aspect, the techniques described herein relate to an image capture device, including: an image sensor; a memory storing processor-readable code; and at least one processor coupled to the memory and to the image sensor, the at least one processor configured to execute the processor-readable code to cause the at least one processor to receive a first image frame and a second image frame in image data received from the image sensor; determine a motion map based on the second image frame and the first image frame; determine, based on the motion map, a region of the second image frame having motion that satisfies at least one criteria; and determine a corrected image frame by applying a temporal filtering process to the region.

In a twenty-seventh aspect according to the twenty-sixth aspect, the at least one criteria includes movement that exceeds a predetermined threshold.

In a twenty-eighth aspect according to at least one of the twenty-sixth through twenty-seventh aspects, processor-readable code further cause the processor to implement an image signal processor containing an image processing engine and an engine for video analytics.

In a twenty-ninth aspect according to the twenty-ninth aspect, applying the temporal filtering process to the region includes determining an image transform matrix, and the image transform matrix is determined by the image processing engine and the region is determined by the engine for video analytics.

In a thirtieth aspect according to at least one of the twenty-sixth through twenty-ninth aspects, the motion map reflects movement within the second image frame relative to the first image frame.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4 and 5 may be combined with one or more blocks (or operations) described with reference to another of the figures. For example, one or more blocks (or operations) of FIG. 4 may be combined with one or more blocks (or operations) of FIGS. 1-3. As another example, one or more blocks associated with FIG. 5 may be combined with one or more blocks (or operations) associated with FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower.” or “front” and back,” or “top” and “bottom.” or “forward” and “backward” are sometimes used for case of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method, comprising:
receiving a first image frame and a second image frame;
determining a motion map based on the second image frame and the first image frame;
determining, based on the motion map, a region of the second image frame having motion that satisfies at least one criteria; and
determining a corrected image frame by applying a temporal filtering process to the region.

2. The method of claim 1, wherein the at least one criteria comprises movement that exceeds a predetermined threshold.

3. The method of claim 1, wherein the method is performed by an image signal processor containing an image processing engine and an engine for video analytics.

4. The method of claim 3, wherein applying the temporal filtering process to the region includes determining an image transform matrix, and wherein the image transform matrix is determined by the image processing engine and the region is determined by the engine for video analytics.

5. The method of claim 1, wherein the method is performed as part of an image processing pipeline, and wherein the first image frame is a reference image frame of the image processing pipeline and the second image frame is a current image frame of the image processing pipeline.

6. The method of claim 1, wherein the motion map reflects movement within the second image frame relative to the first image frame.

7. The method of claim 6, wherein determining the motion map comprises determining differences between the second image frame and the first image frame.

8. The method of claim 6, wherein determining the motion map is based on motion sensor data from an image capture device that captured the first image frame and the second image frame.

9. The method of claim 1, wherein the first image frame was previously transformed to correct motion errors prior to being compared with the second image frame to compute the motion map for the second image frame.

10. The method of claim 1, wherein the image transform matrix is generated according to a motion compensated temporal filtering process.

11. An apparatus, comprising:
a memory storing processor-readable code; and
at least one processor coupled to the memory, the at least one processor configured to execute the processor-readable code to cause the at least one processor to perform operations including:
receiving a first image frame and a second image frame;
determining a motion map based on the second image frame and the first image frame;
determining, based on the motion map, a region of the second image frame having motion that satisfies at least one criteria; and
determining a corrected image frame by applying a temporal filtering process to the region.

12. The apparatus of claim 11, wherein the at least one criteria comprises movement that exceeds a predetermined threshold.

13. The apparatus of claim 11, wherein the at least one processor comprises an image signal processor comprising an image processing engine and an engine for video analytics.

14. The apparatus of claim 13, wherein applying the temporal filtering process to the region includes determining an image transform matrix, and wherein the image transform matrix is determined by the image processing engine and the region is determined by the engine for video analytics.

15. The apparatus of claim 11, wherein the apparatus is performed as part of an image processing pipeline, and wherein the first image frame is a reference image frame of the image processing pipeline and the second image frame is a current image frame of the image processing pipeline.

16. The apparatus of claim 11, wherein the motion map reflects movement within the second image frame relative to the first image frame.

17. The apparatus of claim 16, wherein determining the motion map comprises determining differences between the second image frame and the first image frame.

18. The apparatus of claim 16, wherein determining the motion map is based on motion sensor data from an image capture device that captured the first image frame and the second image frame.

19. The apparatus of claim 11, wherein the first image frame was previously transformed to correct motion errors prior to being compared with the second image frame to compute the motion map for the second image frame.

20. The apparatus of claim 11, wherein the image transform matrix is generated according to a motion compensated temporal filtering process.

21. A non-transitory computer-readable medium storing instructions that, when executed by a processor, cause the processor to perform operations comprising:
receiving a first image frame and a second image frame;
determining a motion map based on the second image frame and the first image frame;
determining, based on the motion map, a region of the second image frame having motion that satisfies at least one criteria; and
determining a corrected image frame by applying a temporal filtering process to the region.

22. The non-transitory computer-readable medium of claim 21, wherein the at least one criteria comprises movement that exceeds a predetermined threshold.

23. The non-transitory computer-readable medium of claim 21, wherein instructions further cause the processor to implement an image signal processor containing an image processing engine and an engine for video analytics.

24. The non-transitory computer-readable medium of claim 23, wherein applying the temporal filtering process to the region includes determining an image transform matrix, and wherein the image transform matrix is determined by the image processing engine and the region is determined by the engine for video analytics.

25. The non-transitory computer-readable medium of claim 21, wherein the motion map reflects movement within the second image frame relative to the first image frame.

26. An image capture device, comprising:
an image sensor;
a memory storing processor-readable code; and
at least one processor coupled to the memory and to the image sensor, the at least one processor configured to execute the processor-readable code to cause the at least one processor to:
receive a first image frame and a second image frame in image data received from the image sensor;
determine a motion map based on the second image frame and the first image frame;
determine, based on the motion map, a region of the second image frame having motion that satisfies at least one criteria; and
determine a corrected image frame by applying a temporal filtering process to the region.

27. The image capture device of claim 26, wherein the at least one criteria comprises movement that exceeds a predetermined threshold.

28. The image capture device of claim 26, wherein processor-readable code further cause the processor to implement an image signal processor containing an image processing engine and an engine for video analytics.

29. The image capture device of claim 28, wherein applying the temporal filtering process to the region includes determining an image transform matrix, and wherein the image transform matrix is determined by the image processing engine and the region is determined by the engine for video analytics.

30. The image capture device of claim 26, wherein the motion map reflects movement within the second image frame relative to the first image frame.
